(19) United States
(12) Patent Application Publication
(10) Pub. No.: US 2006/0060632 A1
(43) Pub. Date: Mar. 23, 2006

(54) Fuel cell stack with edge seal

(76) Inventor: Richard M. Kleber, Clarkston, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 10/946,761

(22) Filed: Sep. 22, 2004

(51) Int. Cl. H01M 2/02; A47J 36/02

(52) U.S. Cl. 228/101; 429/34

(57) ABSTRACT

A stack of sheet metal elements, formed and/or informed, is aligned and compressed so that the edges of the sheet elements form sides of the stack. The edges and intervening interfacial gaps are sealed with molten solder. The practice is particularly applicable to a stack of electrode, current collector and fluid conduit elements for an on-board vehicle fuel cell. The edges of the compressed metal elements are coated and sealed with solder to prevent incursion of contaminants from the vehicle environment and to retain fuel cell fluids.

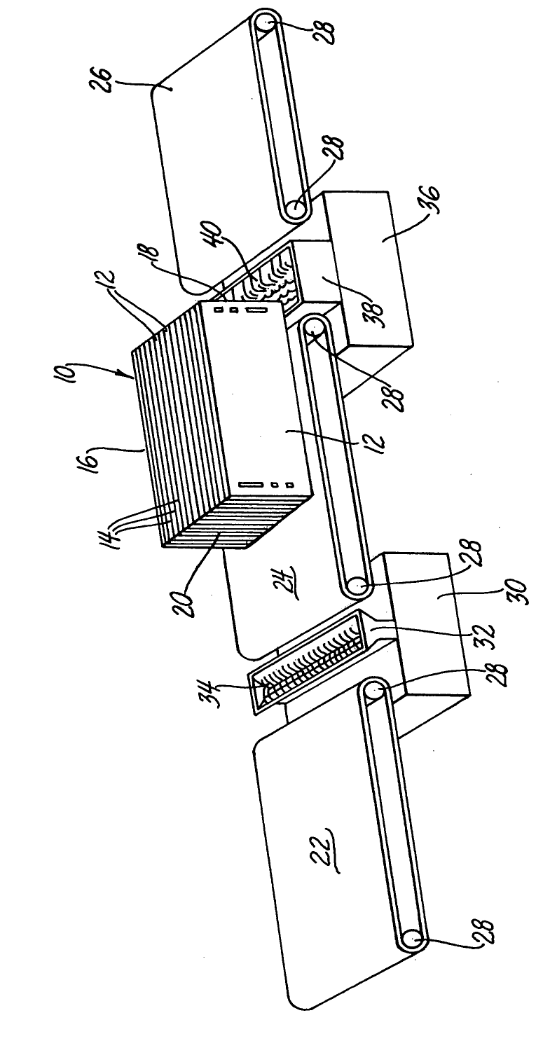

### TECHNICAL FIELD

This invention pertains to a practice for sealing the edges of a compressed stack of preformed and/or unformed sheet metal layers, such as a stack of fuel cell elements. More specifically, this invention pertains to a method of providing a sealing layer of solder metal at and over the edges of such stacked and compressed elements. The solder seal encloses the internal structure of the stacked elements and shields internal conduits or the like from the environment.

### BACKGROUND OF THE INVENTION

Fuel cells that electrochemically combine hydrogen and oxygen are presently being developed and used for production of electric power in stationary and mobile applications. These power sources comprise a stack of individual cell elements that are designed to deliver a power requirement at a specified voltage. The heart of a cell is a membrane electrolyte and electrode assembly (MEA) comprising, for example, a solid polymer, proton exchange electrolyte membrane with a porous catalytic anode on one side of the electrolyte membrane and a porous catalytic cathode on the other side of the membrane. In an assembly of many such cells, each pair of MEAs is separated by a current collector sheet, sealing gasket, and a current collector plate, sometimes called a bipolar plate.

The bipolar plate comprises two thin, facing metal sheets that are shaped to define a flow path on the outside of one sheet for delivery of fluid fuel, for example hydrogen gas, to the anode of one MEA and a flow path for oxygen, often air, on the outside of the second sheet to the cathode side of another MEA on the opposite side of the plate. When the sheets are joined, the surfaces facing between them accommodate the flow of a dielectric cooling fluid. The plates are made of a formable metal that provides suitable strength, electrical conductivity and resistance to corrosion. Stainless steel sheets (316L alloy) of about 0.1 mm gage are an example of a suitable material.

The bipolar plates are assembled with other elements of the fuel cell into a stack of cells sufficient to deliver the electrical power required of the unit. Besides providing flow channels for hydrogen and air on their non-facing sides, the bipolar plates serve as current collectors from cell elements near those sides. The many plates in the stack are connected to an electrical terminal of the stack.

The several stacked elements of the cells are usually made of a conductive metal and have like shapes (often rectangular) so that the edges of the stacked elements form a generally flat surface. But the surface is characterized by thin linear crevices between each sheet or layer in the stack. The stack, which can contain many layers (e.g., more than one hundred) is compressed and the elements held together by bolts through corners of the stack and anchored to frames at the ends of the stack. As stated, openings are provided in the stack for supplying fuel such as hydrogen, an oxidant such as air and for removal of water and other by-products. A liquid coolant may be supplied to the stack, and electrical connections made to it for delivery of electrical power from the stack to its load.

Mechanical compression of the stacked elements prevents intrusion of foreign material between layers and leakage of contained fluids. However, it is an object of this invention to provide a suitable sealing layer of metal over the edges of the many stacked metallic elements. It is a more specific object of the invention to provide such a sealing layer in the form of a solder alloy having a much lower melting temperature than the metal(s) used in the stacked elements.

### SUMMARY OF THE INVENTION

This invention provides a sealing layer of solder metal on the sides of a stacked and compressed body of metal layers. The two-dimensional shape of each layer (i.e., in plan view) is generally the same so that the edges of the stacked sheets are substantially aligned and form flat sides. The “flat” sides are characterized by the edges of adjacent sheet layers with a very small intervening linear gap. Individual sheets in the stack may have internal structure or shape that enables them to perform assigned functions. The stacked sheets are clamped together and held in compression, usually by mechanical means. The invention is particularly applicable to a fuel cell stack but is applicable to other products comprised of stacks of formed and/or unformed (including perforated) metal sheets.

In the fuel stack embodiment, the metal layers are often made from a suitable stainless steel alloy (such as 316L alloy) or aluminum alloy. The individual sheets are typically quite thin, about one tenth of a millimeter in thickness. However, any sheet layer may be stamped or otherwise shaped to define part of a fluid conduit or the like and occupy more space in the compressed stack. The edges of an assembled stack are suitably cleaned and prepared to receive an adherent coating of solder metal. Conventional flux coatings may be used for the specific metal composition of the stack layers and known solder compositions. In some applications it may be preferred to apply a very thin metal pre-coating, e.g., less than a micrometer in thickness to the edges of the stack to make them more receptive to coating with molten solder. In many embodiments of the invention, a conventional tin-silver solder provides a suitable sealing layer on the vulnerable stacked sheet metal edges.

The application of a fluid flux, if used, and molten solder in this new application may be by known flux and solder practices. In accordance with a preferred practice of the invention, solder application is accomplished as follows.

By way of illustration it is assumed that the stack is rectangular in cross-section. Rectangular fuel cell stacks are a common configuration that is convenient to handle and place in a vehicle environment. Structural features of the stacked assembly that are not to be sealed with solder are masked or otherwise protected. These features may include fluid inlets and outlets and electrical connections. The prepared stack is oriented with a first side down and passed through a vertical spray of flux and then through a pool or spillway of molten solder. The solder wets the prepared irregular surface of the stack covering the edges of the respective layers and filling the narrow gaps between them. As the solder coating on a first side of the stack is solidifying, the stack is reoriented for a like solder coating on a second side. This manipulating and handling procedure is repeated until all sides of the stack have been coated as planned.

The resulting solder coated stack is sealed and protected form outside intrusion such as fluids and vapors from an on-board vehicle environment. The solder sealing layer also provides a barrier to fluid escape from the interior of the stack assembly.

Other objects and advantages of the invention will become more apparent from a detailed description of preferred embodiments which follows.

### BRIEF DESCRIPTION OF THE DRAWINGS

The drawing figure is a schematic view of a stack of metal sheet elements being conveyed through a spray of flux material and then through a spillway of molten solder in the solder sealing of one side of a rectangular stack.

### DESCRIPTION OF PREFERRED EMBODIMENTS

In the drawing Figure a stack 10 of metal sheet elements is shown. Stack 10 comprises sheets 12 with sheet layer interfacial gaps 14. In a preferred embodiment stack 10 represents repeated individual cells of a fuel cell stack where each cell comprises, for example, a membrane electrolyte and electrode assembly (MEA). Each MEA is made up of a solid polymer, proton exchange electrolyte membrane with a porous catalytic anode on one side of the electrolyte membrane and a porous catalytic cathode on the other side of the membrane. Each pair of MEAs is separated by a current collector sheet, sealing gasket, and a current collector plate, sometimes called a bipolar plate. The metallic portions of the cells extend to the edge of a stack and present the surfaces to be sealed in accordance with this invention.

In order to simplify the illustration of a practice of the invention, stack 10 does not show the detailed structure of a fuel cell stack. For example, fluid inlets and outlets, electrical connections and stack compression bolts and end frames are not depicted. The purpose of stack 10 as illustrated is to show a plurality of edges of rectangular metal sheet layers 12 with intervening thin gaps 14. As positioned in the Figure, stack 10 has four sides to be coated with solder: upper side 16, front side 18 (indicated but not visible), rear side 20 and a bottom side in contact with conveyer surface 24.

Material handling equipment for accomplishing the solder sealing of stack 10 comprises first continuous conveyer belt surface 22, second continuous conveyer belt surface 24 and third continuous conveyer belt surface 26. Each of continuous conveyer belts 22, 24 and 26 is advanced by powered wheels 28. Continuous conveyer belts 22, 24, and 26 are illustrated as un-imperforated surfaces. But the belts would likely be imperforated or made of a wire mesh or the like to accommodate molten flux and solder on contacting sides of stack 10.

Located between continuous conveyer belts 22 and 24 is a heated molten flux reservoir 30. An unseen pump within flux reservoir 30 propels molten flux through nozzle 32 into a flux spray pattern 34. As a stack 10, which has been placed on its side on conveyer belt 22 and is carried by that belt toward conveyer belt 24, the unseen bottom side of stack 10 is progressively coated in the flux spray. Unabsorbed flux drops back into heated reservoir 30 from which it is re-circulated. The thin flux coating reacts with the exposed surface of the side of stack 10 and reduces surface oxides and the like to prepare the surface for wetting and coating by a suitable molten solder composition.

Stack 10 is advanced from conveyer belt 22 to conveyer belt 24 and toward molten solder heated reservoir 36. An unseen pump within the heated solder reservoir 36 pumps molten solder into a spillway 38 so that there is a generally flat surface 40 of molten solder through which the bottom side of stack 10 is carried as it advances from conveyer belt 24 to conveyer belt 26. A suitable solder composition comprises, by weight, about 96% tin and 4% silver.

After one side of stack 10 has been coated with the solder, the stack is repositioned by conventional mechanical equipment for solder seal coating of another side until the stack has been suitably sealed with a solder layer. Downstream conveyers, flux applicators and solder baths like those depicted in the Figure are suitable.

At the completion of solder coating, stack 10 retains its original shape and function. However, the stack now has a protective thin sealing layer of tin alloy or the like. The sealing layer covers, fills and seals the edges of sheet members 12 and the linear gaps 14 between them.

The flux coating may be replaced by, or supplemented with a thin coating (in the nanometer or micrometer thickness range) of metal such as copper or silver for better receiving the solder seal coating.

The practice of the invention has been illustrated by preferred illustrative example. Other embodiments could readily be adapted by one skilled in the art. The scope of the invention is to be limited only by the following claims.

1. A compressed stack of a plurality of sheet metal elements, the stack comprising:
side surfaces of aligned edges of the sheet elements with linear interfacial gaps between the edges; and
a sealing coating of metal solder covering the edges and gaps on the sides of the stack.

2. A compressed stack of sheet metal elements as recited in claim 1 comprising flux material underlying the sealing coating of metal solder.

3. A compressed stack of sheet metal elements as recited in claim 1 comprising sheet metal elements that have been preformed to define fluid passages between adjacent elements, the sealing coating of solder preventing the incursion of outside materials into said fluid passages.

4. A compressed stack of sheet metal elements for an electrochemical cell, the stack having sides and comprising:
a plurality of electrochemical cell elements comprising an ion exchange membrane disposed between cathode and anode plate elements and one or more separator plate elements, at least some of the sheet metal elements having edges that extend to the sides of the stack;
the sides of the stack being formed by compressing sheet metal elements with the edges aligned; and
a sealing coating of metal solder covering the edges of the elements.

5. A method of sealing the sides of a stack of sheet metal element layers having edges that are aligned to form the sides of the stack, the method comprising:
applying a sealing coating of metal solder to the sides of the stack.

6. A method of sealing the sides of a stack of sheet metal element layers as recited in claim 5 comprising:
immersing a first side of the stack in a molten pool of the solder to wet and coat the edges of the sheets forming the first side;
removing the first side of the stack from the solder to allow the solder to solidify as a sealing coating on the first side; and
progressively immersing and removing other sides of the stack into and from the molten solder to form a sealing coating on each side of the stack.

7. A method of sealing the sides of a stack of sheet metal elements as recited in claim 6 comprising progressively applying a flux for the molten solder to each side of the stack before the side is immersed in solder.

8. A method of sealing a stack of sheet metal elements for a fuel cell, at least some of the sheet metal elements of the stack having alignable edges for defining sides of the stack, the method comprising:
aligning the edges of the sheet metal elements and compressing the sheet metal elements of the stack together to form sides of the stack characterized by adjoining edges and intervening interfacial gaps;
immersing a first side of the stack in a molten pool of the solder to wet and coat the edges and fill the gaps of the sheets forming the first side;
removing the first side of the stack from the solder to allow the solder to solidify as a sealing coating on the first side; and
progressively immersing and removing other side of the stack into and from the molten solder to form a sealing coating on each side of the stack.

9. A method of sealing the sides of a stack of sheet metal elements as recited in claim 8 comprising progressively applying a flux for the molten solder to each side of the stack before the side is immersed in solder.

10. A method of sealing the sides of a stack of sheet metal elements as recited in claim 6 comprising applying a pre-coating of a metal to the sides of the stack to promote wetting by the molten solder, the thickness of the pre-coating being no greater than one micrometer.
